(19) United States
(12) Patent Application Publication
(10) Pub. No.: US 2008/0113736 A1
(43) Pub. Date: May 15, 2008

(54) GAMING MACHINE AND METHOD HAVING A VISUALLY ALTERABLE INDICIA SET

(75) Inventors: Micheal Shackelford, Las Vegas, NV (US); John Vallejo, Las Vegas, NV (US)

Correspondence Address: BALLY GAMING INC., 6601 S. BERMUDA ROAD, LAS VEGAS, NV, 89119, US

(73) Assignee: BALLY GAMING, INC., Las Vegas, NV (US)

(21) Appl. No.: 11/558,827

(22) Filed: Nov. 10, 2006

(51) Int. Cl. A63F 9/24; A63F 13/10; A63F 13/08

(52) U.S. Cl. 463/20; 463/43; 463/31

(57) ABSTRACT

Disclosed are a gaming machine and method for operating a gaming machine including a first light emitter, the first emitter enabled to emit visible light that illuminates at least one of the indicia associated with a game played on the gaming machine. In certain circumstances, a second light emitter emits light that further illuminates the same indicia such that the appearance of the indicia is altered from its original appearance.

### FIELD OF THE INVENTION

The present invention is directed to gaming games and methods and, more particularly, to games and methods that have visually alterable sets of indicia.

### BACKGROUND OF THE INVENTION

In the prior art, various types of gaming machines have been developed with different features to captivate and maintain player interest. In general, a gaming machine allows a player to play a game in exchange for a wager. Depending on the outcome of the game, the player may be entitled to an award which is paid to the player by the gaming machine, normally in the form of currency or game credits. Gaming machines may include flashing displays, lighted displays, or sound effects to capture a player's interest in a gaming device.

Another important feature of maintaining player interest in a gaming machine includes providing the player with many opportunities to win awards, such as cash or prizes. For example, in some slot machines, the display windows show more than one adjacent symbol on each reel, thereby allowing for multiple-line betting. Other types of slot machines have been developed that offer supplemental games that provide players with additional opportunities to win, such as with additional free spins. Some gaming machines offer a player the opportunity to win millions of dollars by providing progressive jackpots. Additionally, supplemental games of various types have been employed to reward players above the amounts normally awarded on a standard game pay schedule. Generally, such supplemental games are triggered by predetermined events such as one or more appearances of certain combinations of indicia in the primary game. In order to stimulate interest, supplemental games are typically set to occur at a gaming machine on a statistical cycle based upon the number of primary game plays.

While gaming machines including supplemental games have been very successful, there remains a need for games that provide a player with enhanced excitement and increased opportunity of winning.

### SUMMARY OF THE INVENTION

In accordance with one embodiment of the invention, a gaming machine includes a central processing unit operatively coupled to a set of player-operated controls; a memory configured to store a wagering game program operable by the central processing unit in accordance with the player-operated controls, at least one display comprising a set of indicia associated with the game program and a first light emitter operatively coupled to the central processing unit and the display, the first emitter enabled to emit visible light that illuminates at least one of the indicia in a first state of illumination. Upon a triggering event, a second light emitter operatively coupled to the central processing unit and the display is enabled to emit light that further illuminates the at least one of the indicia in a second state of illumination such that the appearance of the at least one indicia is altered between the first state and the second state.

In accordance with another embodiment of the invention, a method of operating a gaming machine includes the steps of accepting a wager from a player, initiating play of a game according to the wager and selecting one of a set of possible outcomes of the game, the set of possible outcomes including a winning subset of outcomes. The method further includes, upon a first game state, illuminating one or more indicia on at least one display associated with the game with light from a first source and, upon a second game state, further illuminating the one or more indicia with light from a second source. The light from the second source causes the appearance of the one or more indicia in the second game state to be visually altered from the appearance of the one or more indicia in the first game state.

Other features and advantages will become apparent from the following detailed description, taken in conjunction with the accompanying drawings, which illustrate by way of example, the features of the various embodiments.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a perspective view of a gaming machine in accordance with one aspect of the present invention.

FIG. 2 is a block diagram of the physical and logical components of the gaming machine of FIG. 1.

FIGS. 3A-B are perspective views of a gaming machine associated with a game of one embodiment of the invention.

FIGS. 4A-C are illustrations of a portion of a reel strip at three different stages of illumination, each stage defining different sets of indicia in accordance with one embodiment of the invention.

FIGS. 5A-B are illustrations of a electromechanical wheel at two different stages of illumination, each stage defining different sets of indicia in accordance with one embodiment of the invention.

FIG. 6 is a schematic of a black light assembly suitable for use in a reel mechanism in accordance with one embodiment of the invention.

FIG. 7 is a functional block diagram depicting the steps associated with carrying out a method in accordance of one aspect of the invention.

FIG. 8 is a schematic block diagram showing the hardware elements of a networked gaming system in accordance with one aspect of the present invention.

### DETAILED DESCRIPTION OF THE INVENTION

Various embodiments are directed to a gaming machine and method for operating a gaming machine wherein the indicia set may be visually altered. Embodiments of the gaming machine and method are illustrated and described herein, by way of example only, and not by way of limitation.

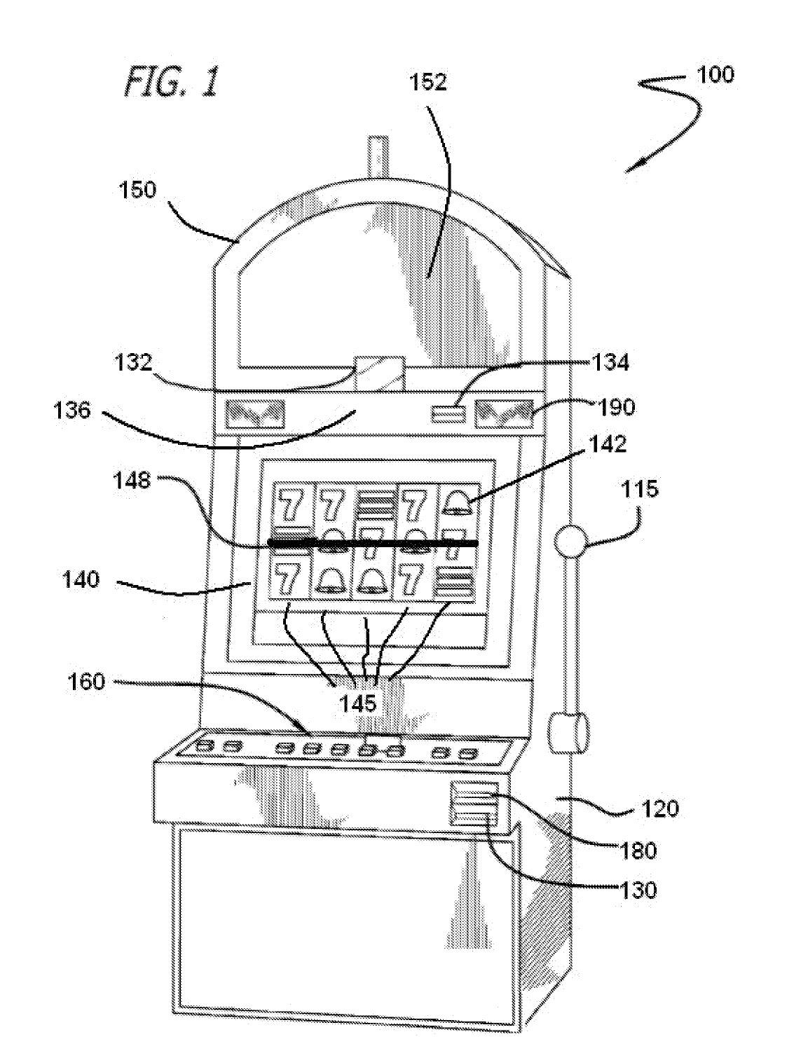

Referring now to the drawings, and more particularly to FIGS. 1-8, there are shown illustrative examples of game and a method for playing a game in accordance with various aspects of the invention.

In accordance with one embodiment, FIG. 1 illustrates a gaming machine 100 including cabinet housing 120, primary game display 140, player-activated buttons 160, player tracking panel 136, bill/voucher acceptor 180 and one or more speakers 190. Cabinet housing 120 is a self-standing unit that is generally rectangular in shape and may be manufactured with reinforced steel or other rigid materials which are resistant to tampering and vandalism. Cabinet housing 120 houses a processor, circuitry, and software (not shown) for receiving signals from the player-activated buttons 160, operating the games, and transmitting signals to the respective displays and speakers. Any shaped cabinet may be implemented with any embodiment of gaming machine 100 so long as it provides access to a player for playing a game. For example, cabinet 120 may comprise a slant-top, bar-top, or table-top style cabinet. The operation of gaming machine 100 is described more fully below.

The plurality of player-activated buttons 160 may be used for various functions such as, but not limited to, selecting a wager denomination, selecting a game to be played, selecting a wager amount per game, initiating a game, or cashing out money from gaming machine 100. Buttons 160 function as input mechanisms and may include mechanical buttons, electromechanical buttons or touch screen buttons. Optionally, a handle 115 may be rotated by a player to initiate a game.

In other embodiments, buttons 160 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 120 may optionally include top box 150 which contains “top glass” 152 comprising advertising or payout information related to the game or games available on gaming machine 100. Player tracking panel 136 includes player tracking card reader 134 and player tracking display 132. Voucher printer 130 may be integrated into cabinet housing 120, player tracking panel 136 or top box 150.

Game display 140 presents a game of chance wherein a player receives one or more outcomes from a set of potential outcomes. For example, one such game of chance is an electro-mechanical slot machine game. In other aspects of the invention, gaming machine 100 may present a video or mechanical reel slot machine, a video keno game, a lottery game, a bingo game, a Class II bingo game, a roulette game, a craps game, a blackjack game, a mechanical or video representation of a wheel game or the like. In alternative embodiments, it may further be appreciated that games of skill or games of chance involving some player skill may be implemented with gaming machine 100.

Mechanical or video/mechanical embodiments may include game displays such as mechanical reels, wheels, or dice as required to present the game to the player. In the case of reels, a mount (not shown) secures and locates each reel 145 to cabinet housing 120 such that one indicium or symbol 142 is aligned with pay line 148 and visible through a window (not shown) of gaming device 100.

In hybrid video/mechanical embodiments, game display 140 may be a CRT or a flat-panel display in the form of, but not limited to, liquid crystal, plasma, electroluminescent, vacuum fluorescent, field emission, or any other type of panel display known or developed in the art. Game display 140 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 140 preferably includes a touch screen or touch glass system (not shown) and presents player interfaces such as, but not limited to, credit meter 144, win meter 142 and touch screen buttons 146. An example of a touch glass system is disclosed in U.S. Pat. No. 6,942,571, entitled “Gaming Device with Direction and Speed Control of Mechanical Reels Using Touch Screen,” which is hereby incorporated by reference.

Game display 140 may also present information such as, but not limited to, player information, advertisements and casino promotions, graphic displays, news and sports updates, or even offer an alternate game. This information may be generated through a host computer networked with gaming machine 100 on its own initiative or it may be obtained by request of the player using either one or more of the plurality of player-activated buttons 160; the game display itself, if game display 140 comprises a touch screen or similar technology; buttons (not shown) mounted about game display 140 which may permit selections such as those found on an ATM machine, where legends on the screen are associated with respective selecting buttons; or any player input device that offers the required functionality.

Cabinet housing 120 incorporates a single game display 140. However, in alternate embodiments, cabinet housing 120 or top box 150 may house one or more additional displays or components (not shown) used for various purposes including additional game play screens, animated “top glass,” progressive meters or mechanical or electromechanical devices such as, but not limited to, wheels, pointers or reels. The additional displays may or may not include a touch screen or touch glass system.

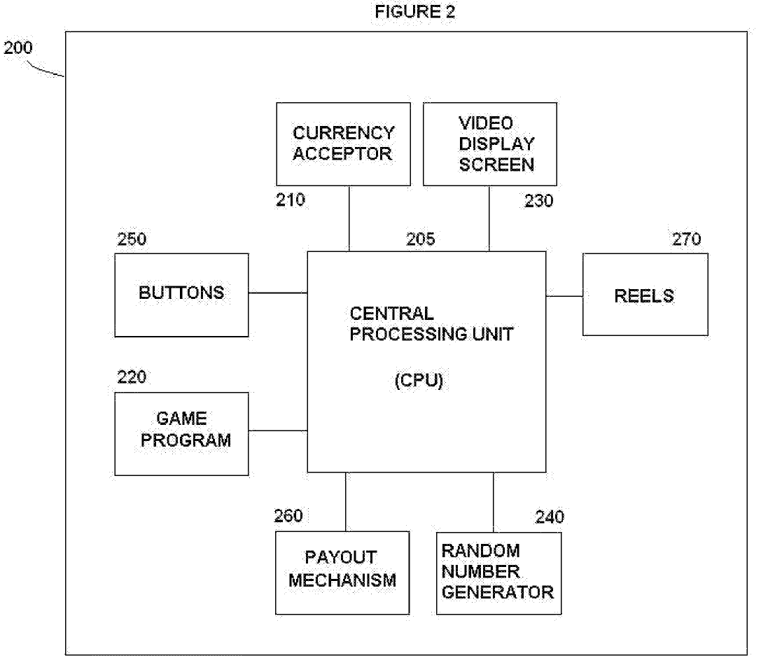

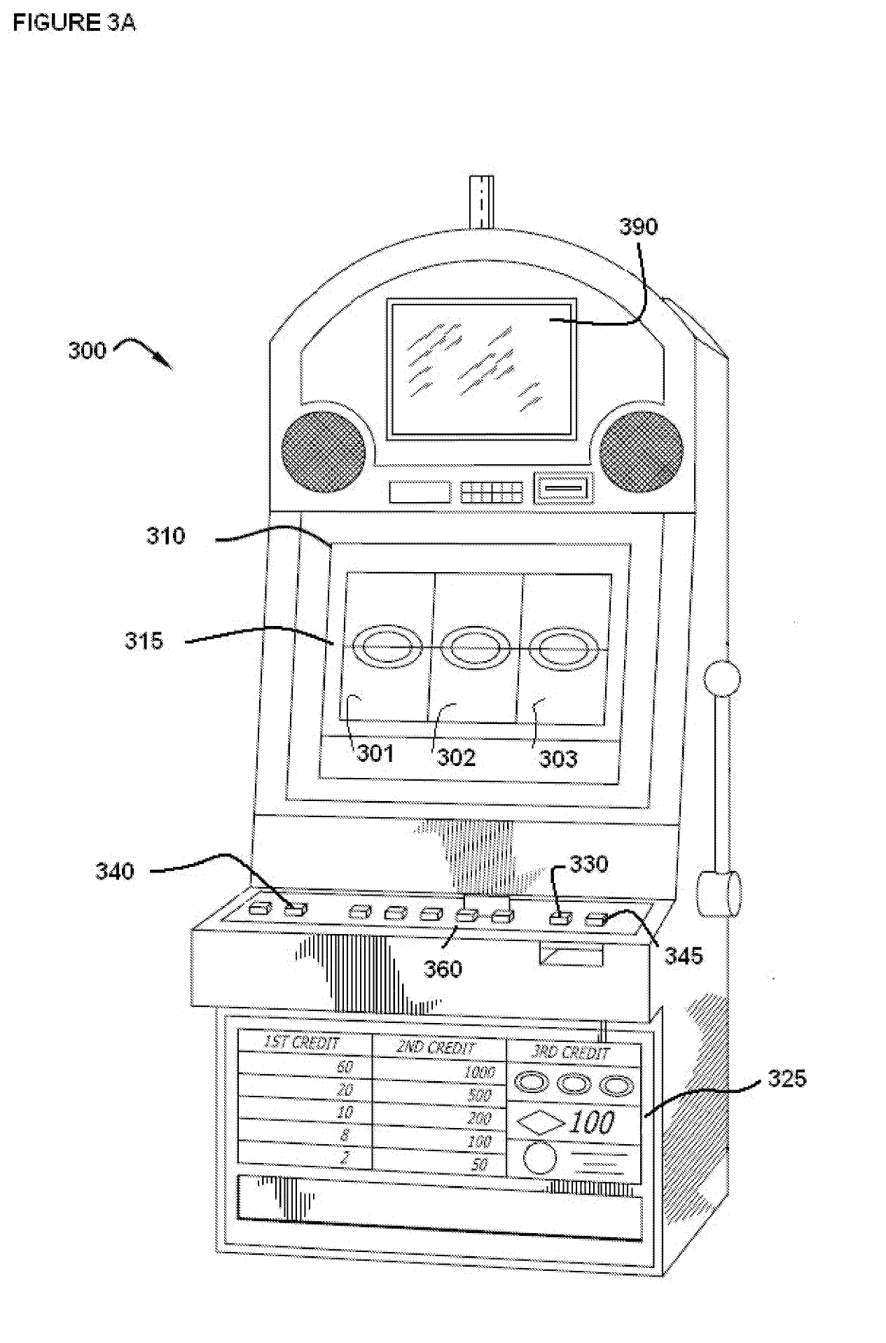

In accordance with one embodiment of the present invention, FIG. 2 is a block diagram showing the interconnection of physical and logical components 200 of gaming machine 100. Currency acceptor 210 is typically connected to central processing unit (“CPU”) 205 by a serial connection such as RS-232 or USB. CPU 205 executes game program 220 that causes reels 270 to display a game outcome. In one embodiment, in accordance with conventional design, each reel 270 preferably includes a stepper motor to spin the reel. Each reel further includes an outer rim portion on which the game indicia are located. CPU 205 directly or indirectly provides a drive signal to the stepper motors associated with reels 270 that causes the reels to spin. The CPU unit also provides signals to the stepper motors associated with reels 270 to cause the reels to halt in a particular position and to display outcome symbols aligned with a pay line (FIG. 1,148) that correspond to a particular outcome symbol combination (i.e., game outcome or result).

The mechanism for each reel 270 may include illumination devices such as, for example, light bulbs, single color light emitting diodes (LEDs), multi-color (RGB) LEDs or the like for back-illumination of the indicia on the reel strips. Other embodiments may front- or side-light the indicia with black light. Various embodiments of the invention, at various stages of game play, employ one or more black light LEDs and special inks or substances sensitive to black light on at least some of the indicia in order to further illuminate the indicia, altering the appearance of some or all of the indicia. Black light, also known as Wood's light, is a common name for a source emitting electromagnetic radiation that is almost exclusively in the soft near ultraviolet range. Black light contains very little visible light and, to the human eye, looks much more violet than black. The ultraviolet radiation is invisible to the human eye, but illuminating certain materials with UV radiation creates the visible effects of fluorescence and phosphorescence such that the materials containing phosphors become self-illuminating. For example, one embodiment uses a Teledyne 9-up “photon engine” comprising nine ultraviolet light-emitting diodes to illuminate indicia at least partially printed with UV-sensitive ink on a reel strip. One version of the photon engine has radiant power of approximately 1 watt and produces light in the range of approximately 370 nm to 430 nm with most light produced at a wavelength of approximately 400 nm, however, any light source that causes materials to visibly self-illuminate or otherwise alter their appearance may be used in conjunction with normal visible light illumination. In some embodiments, a varying number of UV emitters of higher or lower wattage may be used depending on the requirements of the game. To avoid heat issues, the emitters may be mounted on or attached to a suitable heat sink material, for example, aluminum, may be ventilated, or used for limited durations.

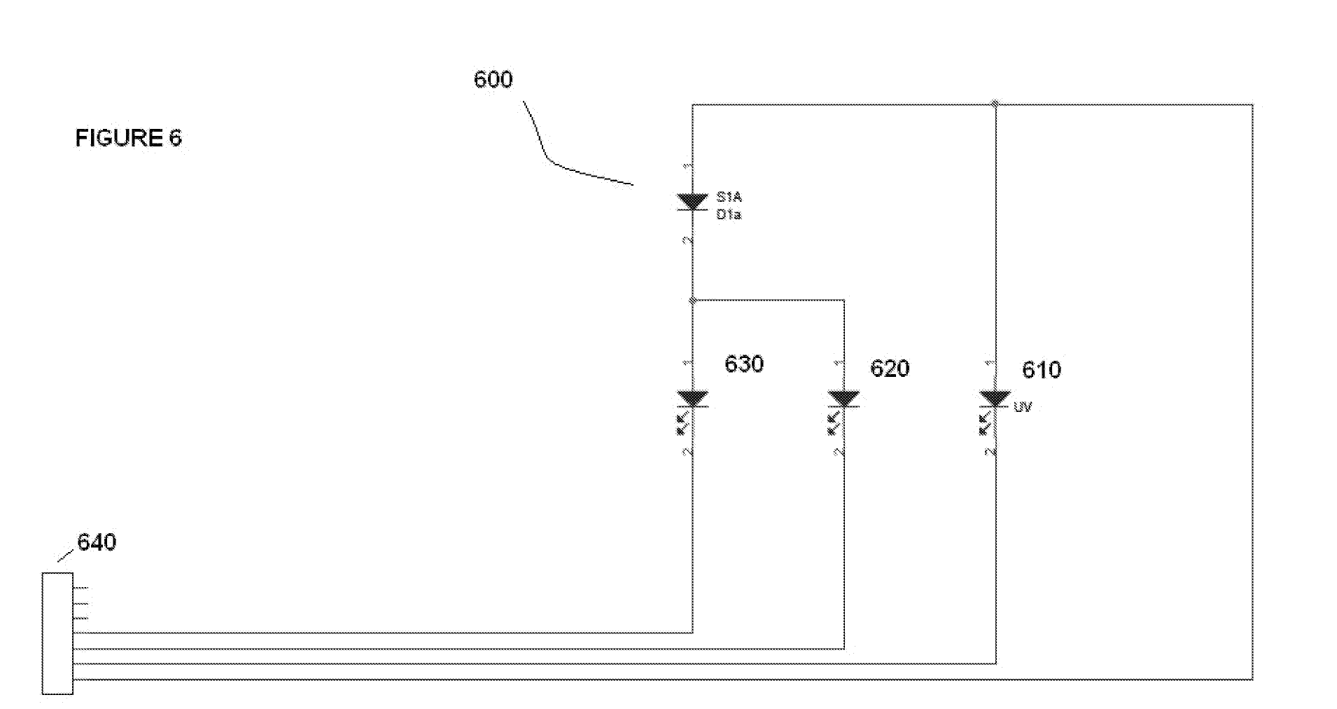

To prevent a player from attempting to falsely claim a winning combination by illuminating black-light-sensitive indicia with his own light source, a surface between the player and the reel strip, for example the window in front of the reels or the top layer of the reel strip itself, may be coated with a UV filter. In one embodiment, the black light emitters are built into dedicated assemblies. In another embodiment, the black light emitters are integrated with other lighting components such as, for example, color LEDs, to produce a general-purpose reel strip illumination device. For example, in accordance with one embodiment, FIG. 6 illustrates a reel backlight printed circuit board 600 employing both a UV LED 610 and RGB LEDs 620 and 630. The printed circuit board attaches to the gaming machine by way of connector 640. At one stage of the game, the RGB LEDs are used to backlight game indicia. At a second stage of the game, both the RGB LEDs and the UV LED are enabled, creating an appearance of the indicia different from the appearance they had when illuminated only with the RGB LEDs.

Returning to FIG. 2, when a player has inserted a form of currency such as, for example and without limitation, paper currency, coins or tokens, cashless tickets or vouchers, electronic funds transfers or the like into currency acceptor 210, a signal is sent to CPU 205 which, in turn, assigns an appropriate number of credits for play. The player may further control the operation of gaming machine 100, for example, to select the amount to wager via electromechanical or touchscreen buttons 250. The game starts in response to the player pushing one of buttons 250. Random number generator 240 responds to instructions from CPU 205 to provide a display of randomly selected indicia on reels 270. CPU 205 under control of game program 220 compares the final display of indicia to a pay table. The set of possible game outcomes may include a subset of outcomes related to the triggering of play of additional games. In the event the displayed outcome is a member of this subset, CPU 205, under control of game program 220, causes additional game play to be presented on reels 270 as will be described further below.

Predetermined payout amounts for certain outcomes, including bonus game outcomes, are stored as part of game program 220. Such payout amounts are, in response to instructions from CPU 205, provided to the player in the form of coins, credits or currency via payout mechanism 260, which may be one or more of a credit meter, a coin hopper, a voucher printer, an electronic funds transfer protocol or any other payout means known or developed in the art.

In various embodiments of gaming machine 100, game program 220 is stored in a memory device (not shown). By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 100 are stored in the same or a separate memory device (not shown).

In various embodiments of the invention, a supplemental game is available to the player. In one embodiment, the set of possible primary game outcomes includes a subset of outcomes related to the triggering of supplemental game play. In an alternate embodiment, other elements of the primary game trigger a supplemental game. Once a supplemental game has been triggered, the player is awarded a certain number of supplemental game plays for which they may, or may not, pay. The composition of the indicia set (reels, card decks, etc.) and pay table used in each supplemental game may be determined by the triggering event and may differ in appearance from those used by the primary game.

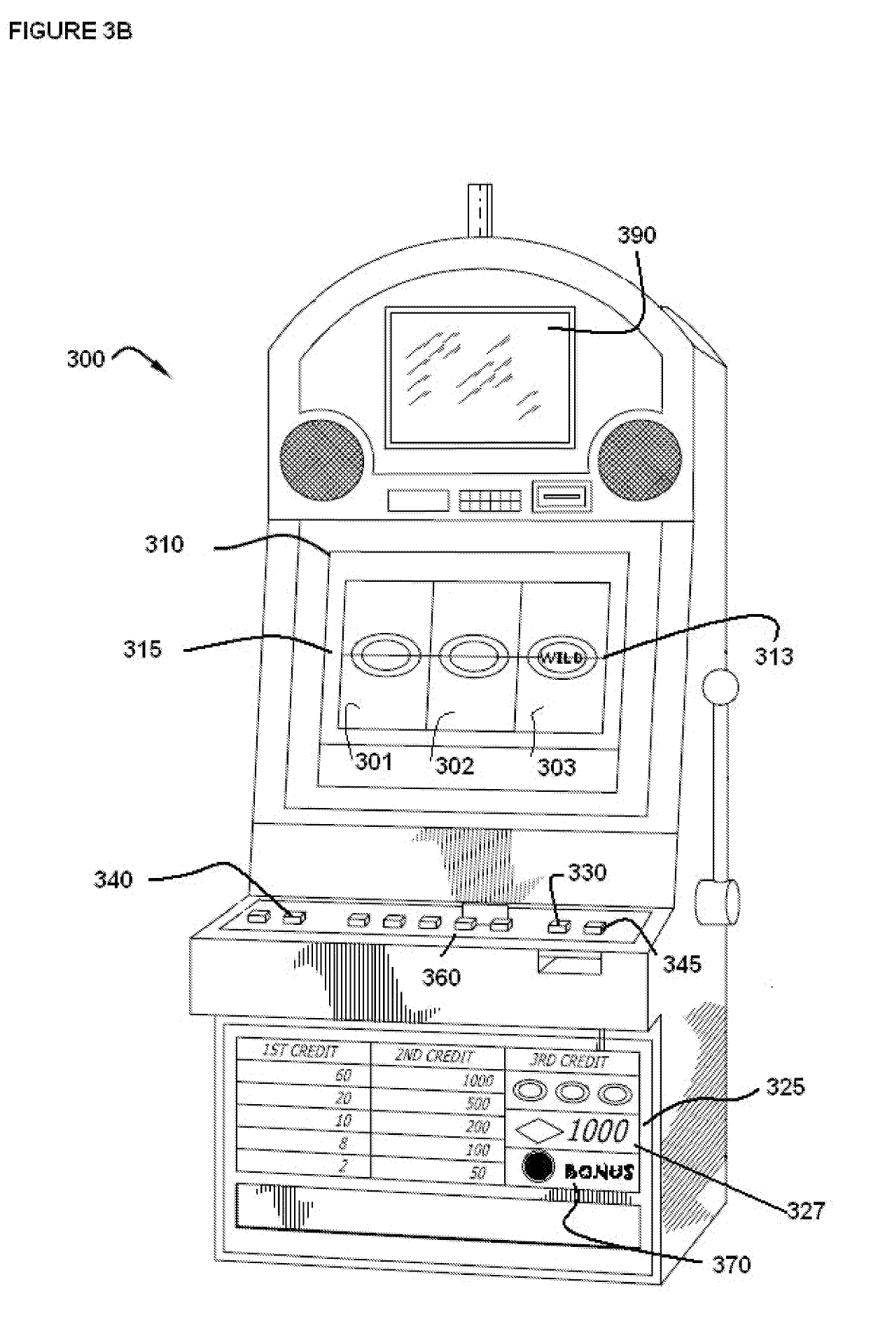

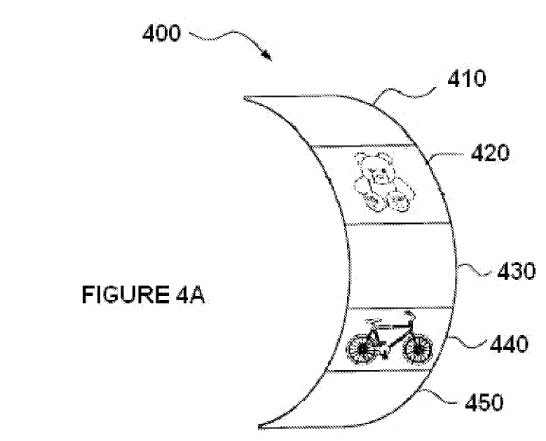

FIGS. 3A-3B represent a game 300 including indicia in various stages of black light illumination in accordance with one embodiment of the invention. Turning now to FIG. 3A, game 300 is implemented on display 310 using spinning reels 301-303. A pay line 315 superimposed over reels 301-303 on a transparent window passes “through” one indicium on each of the reels 301-303. The number of pay lines and their patterns are by way of example only and may vary. The player selects the number of number of credits or coins wagered using one or more buttons 360. The player may also collect the balance of his credits by pressing cash out button 340.

The player initiates game play by pressing SPIN button 330. In some embodiments, the player may play at the maximum number of coins or credits allowed by pressing a MAX BET button 345. Reels 301-303 are made to spin and stop in predetermined stop positions and it is determined whether the stop positions of the reels resulted in a winning game outcome.

Winning outcomes may be indicated on a pay table 325, which may be printed, for example, on glass or plastic. In addition to winning outcomes, the pay table may provide disclaimers, rules of the game or indicators of the mode of the game. In alternate embodiments, the pay table may be presented on a video display 390 attached to the gaming machine. A winning combination, for example, could be three or more oval symbols adjacent to one another on pay line 315. For each winning combination, the game device awards the player the award in the pay table, adjusted as necessary based on the number of credits wagered. Some representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to be result in pay amounts in excess of the normal winning combination by way of multiplication or addition, for example, a wild doubler symbol may be used.

Some game outcomes can be utilized to trigger the play of additional games, including, but not limited to, awarding bonus play when certain symbols appear on a pay line, when certain symbols are scattered, when no symbols of a certain type appear, when a certain winning combination occurs or, regardless of the visible symbols, at random or fixed intervals. In other embodiments, free games that do not use reels may be awarded. For example and without limitation, free games that present cards, roll dice, spin wheels, or offer a “second screen” bonus may be awarded either on the primary game display or on a separate display or device, for example on a video display or mechanical wheel. Multipliers may or may not be applied to pays during free games. Free games may include scatter pays or be implemented on reels which are separate from the base game.

In accordance with one embodiment, the game transitions from a standard play mode, represented by FIG. 3A, to a bonus play mode, represented by FIG. 3B, upon the occurrence of a bonus play trigger. Turning to FIG. 3B, in order to provide a more attractive, entertaining and lucrative bonus experience for the player, indicia on the reels and the pay table, as well as pay table values associated with those indicia, are illuminated with black light to alter their appearance. For example, on pay table 325, the award 327 for the diamond symbol has had an additional “0” revealed by black light, changing the value from “100” on FIG. 3A to “1000” on FIG. 3B. A bonus mode indicator 370 is illuminated and has become visible. In one embodiment, special rules (not shown) become visible. Symbol 313 on reel 303, in addition to serving as an oval symbol, displays a new “WILD” attribute associated with this particular oval. Other oval symbols on the reels may or may not be affected.

The player may press a “start” button (not shown) at the beginning of each free game, or the games may proceed automatically. The reels are spun and stopped, then evaluated for any winning combinations. If winning combinations are present, the combinations are evaluated against the bonus mode pay table and awarded to the player on a bonus win meter (not shown). In another embodiment, bonus wins are paid immediately following each bonus mode game.

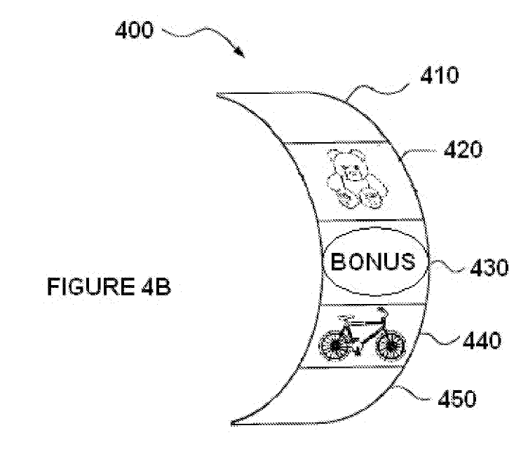

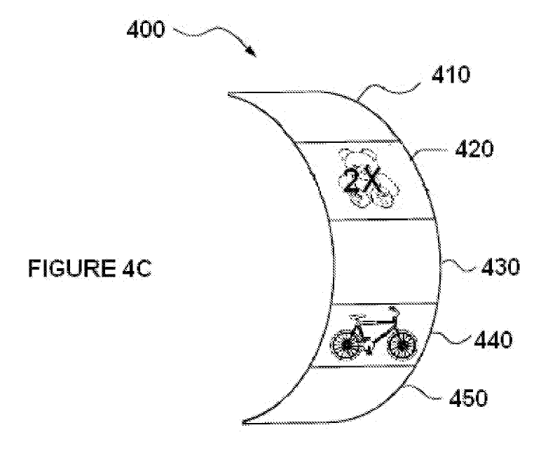

FIGS. 4A-4D represent a portion of a slot machine reel strip having indicia in regions in various stages of black light illumination in accordance with one embodiment of the invention. Each region may be individually illuminated with black light.

In FIG. 4A, reel strip 400 is shown having separate regions 410, 420, 430, 440 and 450, all displayed without black light illumination. Region 41 0 appears blank, region 420 contains a bear symbol, region 430 appears blank, region 440 contains a bicycle symbol and region 450 appears blank.

FIG. 4B presents slot machine reel 400 in a different state of illumination. In this state, regions 410, 420, 440 and 450 remain unchanged. That is, they are not black light illuminated. Region 430 has been illuminated with black light, causing a previously invisible bonus symbol (on FIG. 4A) to become visible.

FIG. 4C presents slot machine reel 400 in a different state of illumination. In this state, regions 410, 430, 440 are not illuminated with black light. Region 420 has been illuminated with black light, causing a previously invisible multiplier (“2×”) symbol to become visible as part of the bear symbol. Region 450, though illuminated with black light, does not contain any indicia visible under black light illumination and thus, appears unchanged from FIGS. 4A and 4B.

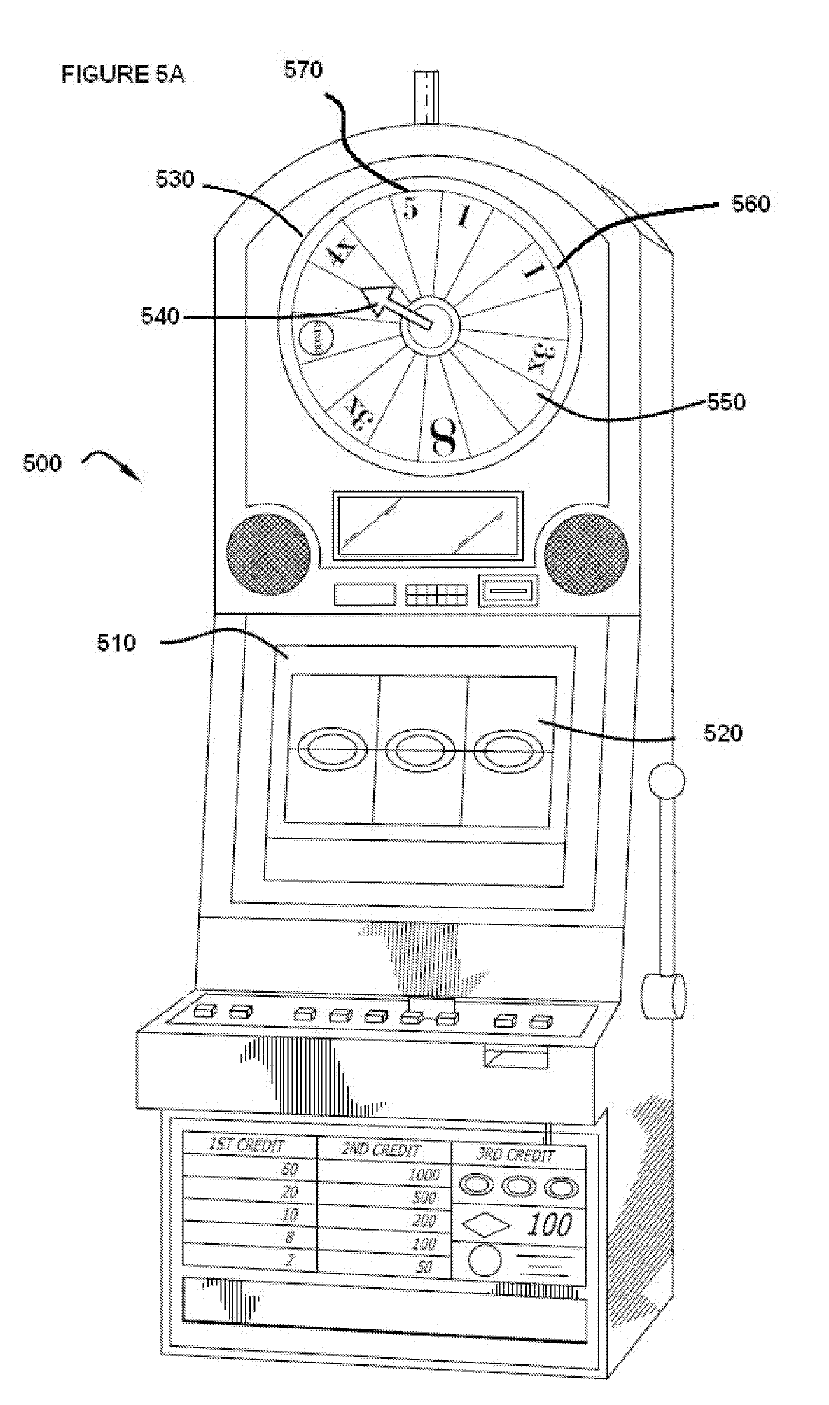

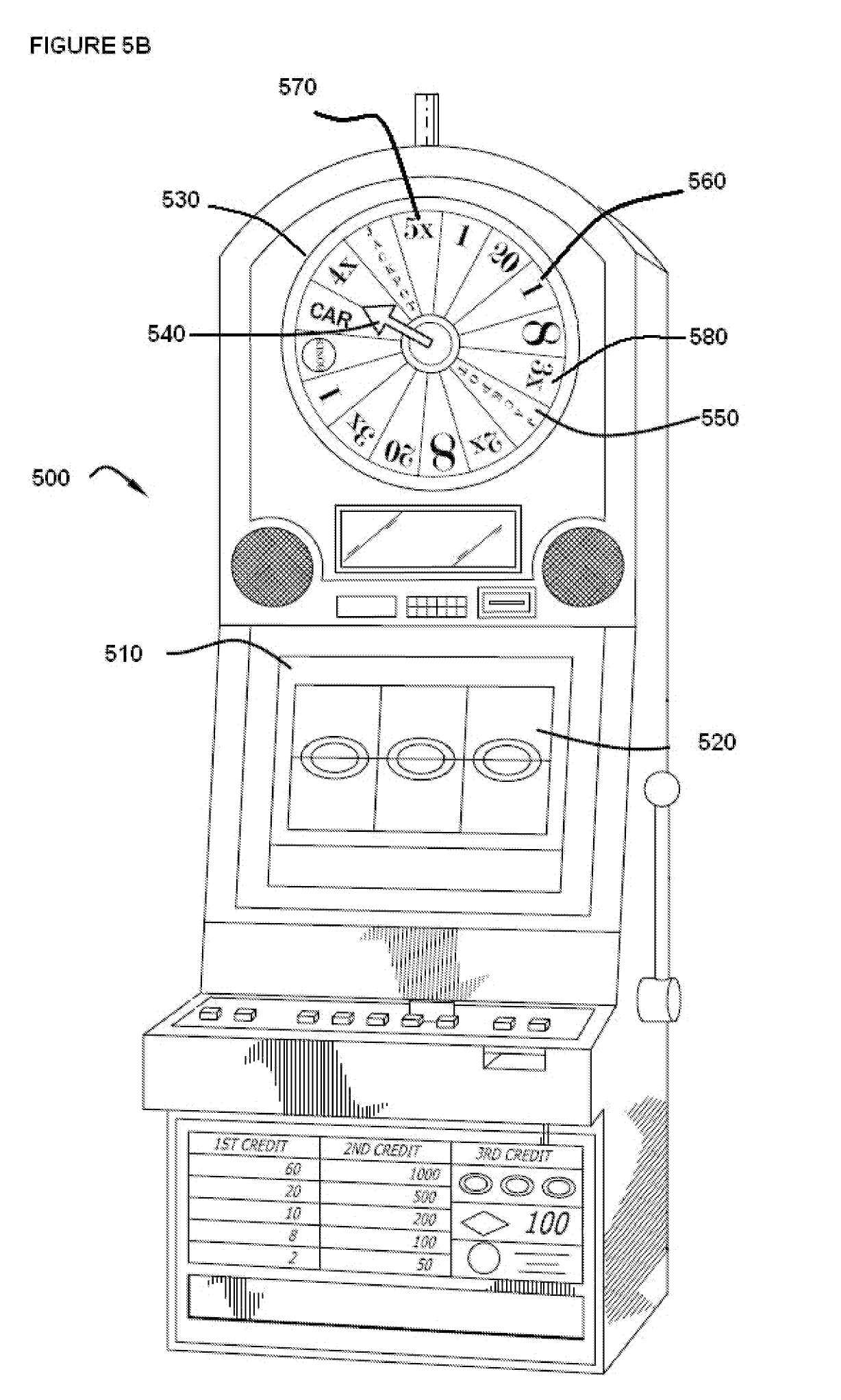

Turning to FIG. 5A, in accordance with one embodiment of the invention, a gaming machine 500 includes a primary game display 510 in the form of one or more indicia bearing reels 520. Gaming machine 500 also includes an electromechanical wheel including pointer 540 and wheel face 530 with segments 560 arranged around a central axis. One or more of the segments includes indicia, for example, numbers (1, 10, 25, etc.), words (CAR, JACKPOT, LOSE, RESPIN, etc.), slot machine symbols (fruit, bars, etc.), multipliers (1×, 2×, 5×, etc.) or the like. At least one of pointer 540 and wheel face 530 moves to indicate a primary or secondary game outcome, in whole or in part, based on the indicia pointed to by the pointer when both the wheel and the pointer become stationary following a period of movement. A segment may appear blank, for example, to indicate that the segment represents no award. In some embodiments, no segments appear blank. At least one segment 550 includes indicia invisible to the human eye unless illuminated, for example, back-lit, by black light. Proceeding to FIG. 5B, with the illumination of segments 550 with black light, indicia not previously visible become visible and active as potential awards on wheel face 530. In some cases, portions of indicia were visible under normal light while other portions of the same indicia were invisible unless exposed to black light. For example, segment 570 appears as a “5” award in FIG. 5A, but appears as a “5×” multiplier award when illuminated with black light in FIG. 5B.

In an alternate embodiment, the wheel and pointer are implemented as a “light box” game and do not move. Rather, at least one segment of the wheel is lit in a manner that signifies that it is the currently indicated segment. Indicia on the face of the wheel may be visually altered as described above. In another embodiment, the light box game takes a form other than a wheel, for example, a matrix of indicia may be displayed and visually altered.

To prevent illumination from unauthorized sources, in some embodiments, a UV filtering layer is placed in front of the black light-sensitive indicia on the wheel face. For example, this may be accomplished by treating the face of the wheel, a transparent cover in front of the wheel, or the top layer of the individual indicia.

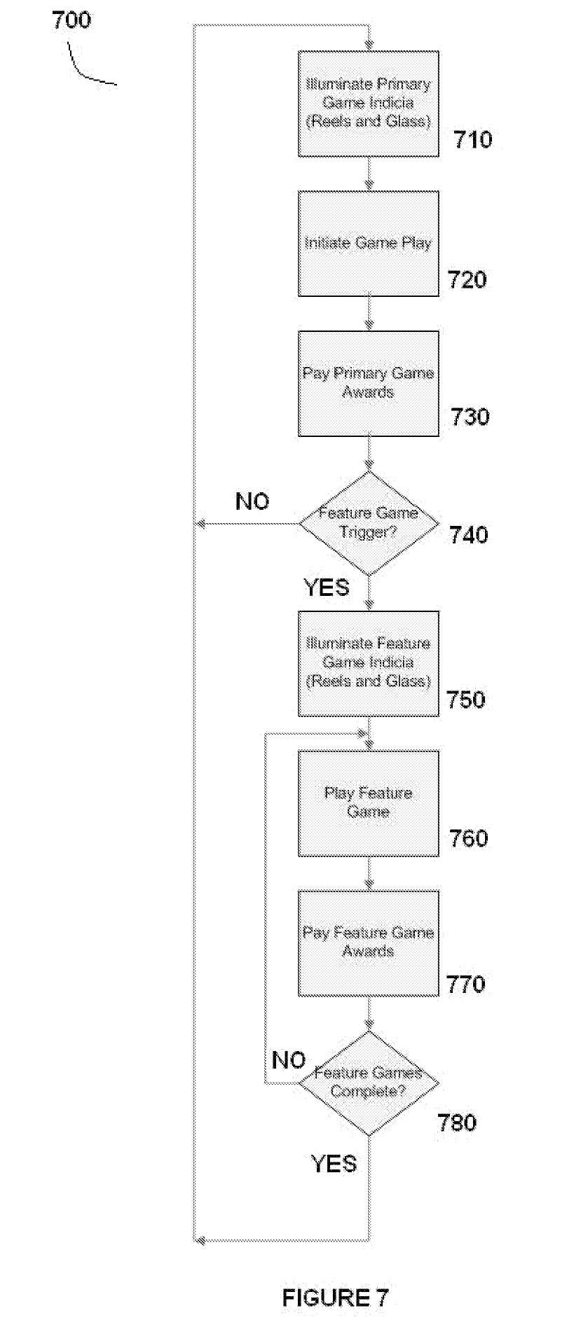

A logical flow diagram generally depicting the steps associated with a method 700 for carrying out a game having a visually alterable set of indicia, in accordance with one aspect of the invention, is presented in FIG. 7. The order of actions as shown in FIG. 7 and described below is only illustrative, and should not be considered limiting. For example, the order of the actions may be changed, additional steps may be added or some steps may be removed without deviating from the scope and spirit of the invention.

First, the primary game is initialized at block 710. The symbols on the reels and pay glass are illuminated according to the set of indicia and pay table used for a primary game. The player initiates game play at block 720 and the reels are spun and stopped to determine a game outcome. Any awards due the player as a result of evaluating the displayed primary game indicia against the primary pay table are paid at block 730.

The primary game outcome is compared to a predefined feature game trigger at decision block 740. For example, the appearance of three lemons on a pay line may have been predetermined to be the trigger for feature game play.

If the triggering event for the feature game has not occurred, the method returns to block 710 and prepares for another primary game play.

Otherwise, the primary game indicia and pay table are “replaced” by the feature game indicia by supplementing the illumination of the reel strips and pay table with black light so that the indicia and corresponding pay table for the feature game are visible, block 750. The feature game is then played by spinning the reels and stopping them to determine a feature game outcome at block 760. Any awards associated with the outcome of the feature game are paid at block 770. Multiple iterations of blocks 760-770 are possible. At step 780, the decision whether or not to play another iteration of the feature game is made. The decision rules may be predetermined by the rules of the game, determined at the time the feature game is triggered, or determined “on the fly.” When it is determined that play of the feature game is complete, the primary game play is reinitialized at block 710.

It should be noted that the feature game, while similar in operation to the primary game, has a unique presentation set of indicia and pay table made possible by the application of special lighting affects that visually alters the image of at least one of one or more reel symbols or one or more pay values.

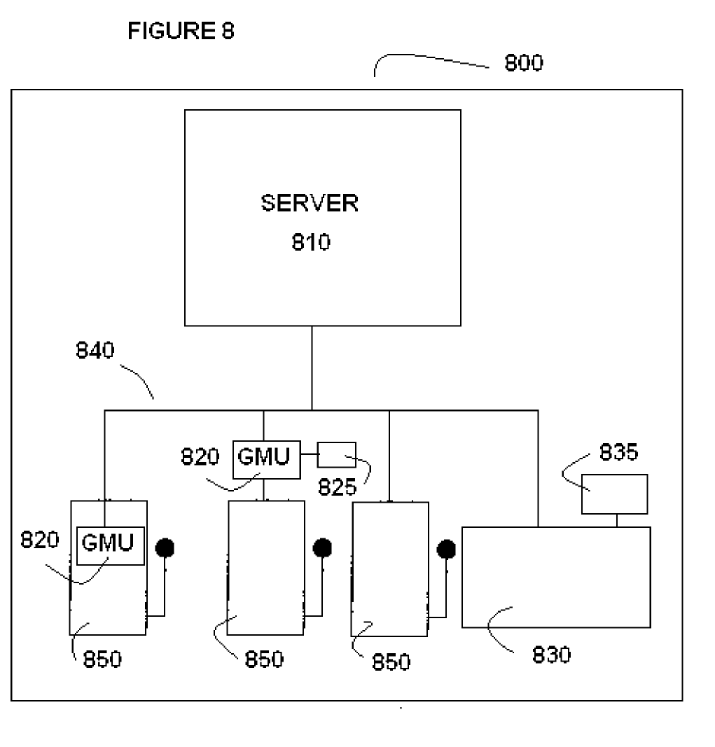

Referring to FIG. 8, in accordance with one aspect of the invention, gaming system 800 includes server 810, gaming machines 850, and network 840 connecting gaming machines 850 to server 810. Additionally, gaming display computer 830 is shown connected to network 840. Server 810 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 810 may be configured as a single “logical” server that comprises multiple physical servers. Gaming machines 850 operate similar to conventional peripheral networked terminals. Gaming machines 850 have a player interface such as a display, a card reader, and selection buttons through which gaming machines 850 interact with a player playing a wagering having games with visually alterable sets of indicia. The player interface is used for making choices such as the amount of a bet or the number of lines to bet. Gaming machines 850 also provide information to server 810 concerning activity on gaming machines 850 and provide a communication portal for players with server 810. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 850 may be a mechanical reel spinning slot machine, video slot machine, video poker machine, keno machine, video blackjack machine, or a gaming machine offering one or more of the above described primary games offering a visually alterable set of indicia. Networking components (not shown) facilitate communications across network 840 between the system server 810 and game management units 820 and/or gaming display control computers 830 that control displays for carousels of gaming machines. Game management units (GMU's) 820 connect gaming machines to networking components and may be installed in the gaming machine cabinet or external to the gaming machine. The function of the GMU is similar to the function of a network interface card connected to a desktop personal computer (PC). Some GMU's have much greater capability and can perform such tasks as presenting and playing a game having a visually alterable set of indicia using a display 825 operatively connected to the GMU 820. Displays related to games including a visually alterable set of indicia on gaming machines 850 or GMU displays 825 may also be presented on gaming display 835 by gaming display control computer 830. In one embodiment, the GMU 820 is a separate component located outside the gaming machine. Alternatively, in another embodiment, the GMU 820 is located within the gaming machine. Optionally, in an alternative embodiment, one or more gaming machines 850 connect directly to the network and are not connected to a GMU 820. A gaming system of the type described above also allows a plurality of games in accordance with the various embodiments of the invention to be linked under the control of server 810 for cooperative or competitive play in a particular area, carousel, casino or between casinos located in geographically separate areas.

One will appreciate that a gaming system may also comprise other types of components, and the above illustrations are meant only as examples and not as limitations to the types of components or games having a visually alterable set of indicia in a gaming system. Additionally, it may further be appreciated that each of the games could be operated on a remote host computer such that a player initiates play with the host computer over a network via the player interface and gaming machine 850 operates the respective gaming and video displays in conjunction with the game whose play, including visually altering indicia, is controlled by the remote computer.

The various embodiments described above are provided by way of illustration only and should not be construed to limit the invention. For example, some or all of the indicia may have varying degrees of opacity to allow the normal light back-lighting to be visible to the player through the indicia. The black-light sensitive indicia may include layers. A back layer includes the UV ink portion of the indicia. A middle translucent layer includes the normally visible portion of the indicia. A top layer may be largely opaque, cut-out only where indicia reside so that the indicia are the only elements of the reel strip highlighted when back-lit. Other layers may be used or the order of the layers changed depending on the specific game being implemented. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A gaming machine comprising:
a central processing unit operatively coupled to a set of player-operated controls;
a memory configured to store a wagering game program operable by the central processing unit in accordance with the player-operated controls;
at least one display comprising a set of indicia associated with the game program;
a first light emitter operatively coupled to the central processing unit and the display, the first emitter enabled to emit visible light that illuminates at least one of the indicia in a first state of illumination,
a second light emitter operatively coupled to the central processing unit and the display, upon a triggering event, the second emitter enabled to emit light that further illuminates the at least one of the indicia in a second state of illumination, such that the appearance of the at least one indicia is altered between the first state and the second state.

2. The gaming machine of claim 1 wherein the at least one display comprises a mechanical reel.

3. The gaming machine of claim 1 wherein the at least one display comprises a mechanical wheel.

4. The gaming machine of claim 1 wherein the at least one display comprises a light wheel.

5. The gaming machine of claim 1 wherein the at least one display comprises a light box game.

6. The gaming machine of claim 1 wherein the at least one display comprises a pay table.

7. The gaming machine of claim 1 wherein the indicia set is associated with awards associated with the game program.

8. The gaming machine of claim 1 wherein the indicia set is associated with rules associated with the game program.

9. The gaming machine of claim 1 wherein the indicia set is associated with a mode associated with the game program.

10. The gaming machine of claim 1 wherein the light emitted by the second emitter is black light.

11. The gaming machine of claim 1 further comprising a filter that shields the at least one indicia to prevent the further illumination by an unintended second emitter.

12. A method of operating a gaming machine, the method including the steps of: accepting a wager from a player; initiating play of a game according to the wager; selecting one of a set of possible outcomes of the game, the set of possible outcomes including a winning subset of outcomes; upon a first game state, illuminating one or more indicia on at least one display associated with the game with light from a first source; upon a second game state, further illuminating the one or more indicia with light from a second source, the light from the second source causing the appearance of the one or more indicia in the second game state to be visually altered from the appearance of the one or more indicia in the first game state.

13. The method of claim 12 wherein the at least one display comprises a mechanical reel.

14. The method of claim 12 wherein the at least one display comprises a mechanical wheel.

15. The method of claim 12 wherein the at least one display comprises a light wheel.

16. The method of claim 12 wherein the at least one display comprises a light box game.

17. The method of claim 12 wherein the at least one display comprises a pay table.

18. The method of claim 12 wherein the one or more indicia are associated with awards associated with the game program.

19. The method of claim 12 wherein the one or more indicia are associated with rules associated with the game program.

20. The method of claim 12 wherein the one or more indicia are associated with a mode associated with the game program.

21. The method of claim 12 wherein the second light source emits black light.

22. The method of claim 12 wherein the one or more indicia are shielded from illumination by an unintended second light source by a filter.
